(19) United States
(12) Patent Application Publication
(10) Pub. No.: US 2024/0002658 A1
(43) Pub. Date: Jan. 4, 2024

(54) Flame-Retardant, Titanium Dioxide-Containing Polycarbonate Compositions

(71) Applicant: Covestro Deutschland AG, Leverkusen (DE)

(72) Inventors: Rolf Wehrmann, Krefeld (DE); Helmut Werner Heuer, Siegen (DE); Anke Boumans, Bedburg-Hau (DE)

(21) Appl. No.: 18/037,866

(22) PCT Filed: Nov. 18, 2021
(86) PCT No.: PCT/EP2021/082129

§ 371 Date: May 19, 2023

(30) Foreign Application Priority Data
Nov. 23, 2020 (EP) 20209239.1

(51) Int. Cl. C08L 69/00; C08K 3/22; C08K 5/42; G02B 1/04

(52) U.S. Cl. CPC C08L 69/00; C08K 3/22; C08K 5/42; G02B 1/04; C08L 2203/30; C08L 2201/02; C08L 2207/53; C08L 2207/324; C08L 2205/025; C08L 2205/035; C08K 2003/2241; G02B 5/08

(57) ABSTRACT

What are described are titanium dioxide-containing thermoplastic compositions based on polycarbonate having high reflectance, to which, for further improving the reflectance, are added at least one graft polymer of (C₁ to C₈)-alkyl (meth)acrylate on a graft base from the group of acrylate rubbers, in particular one with core/shell structure based on butyl acrylate.

### CROSS-REFERENCE TO RELATED APPLICATIONS

This application is the United States national phase of International Application No. PCT/EP2021/082129 filed Nov. 18, 2021, and claims priority to European Patent Application No. 20209239.1 filed Nov. 23, 2020, the disclosures of which are hereby incorporated by reference in their entireties.

### BACKGROUND OF THE INVENTION

### Field of the Invention

The invention provides flame-retardant, titanium dioxide-containing polycarbonate-based compositions having high reflectance and good melt stability. The present invention further relates to mold formed from these compositions, for instance for housings/housing parts or other elements in the electricals and electronics and IT sectors, for example for bezels and switches for automotive interior illumination and in particular for reflectors of illumination units such as LED lamps or LED arrays.

### Description of Related Art

It is known from the prior art to add titanium dioxide to plastics such as polycarbonate in order to improve reflectance.

CN 109867941 A for instance describes a reflective polycarbonate material containing titanium dioxide, a liquid silicone and further polymeric constituents.

Furthermore, a multiplicity of flame retardants suitable for polycarbonate and preferably added to the plastics material for applications in the electricals and electronics and IT sectors are known.

TW 200743656 A discloses flame-retardant, halogen-free, reflective polycarbonate compositions which, in addition to titanium dioxide, contain inorganic fillers such as clay or silica and further organic components such as optical brighteners, perfluoroalkylene compounds and metal salts of aromatic sulfur compounds.

JP 2010138412 A describes flame-retardant titanium dioxide-containing polycarbonate compositions containing silicone compounds, PTFE and inorganic components such as talc, mica or glass.

For components, such as reflectors for example, there is a demand for compositions having ever higher reflectance in order to utilize the energy used as well as possible. At the same time, good flame retardancy properties are often desired, since the compositions having high reflectance are typically used in the electricals and electronics or automotive sector.

However, the addition of flame retardants typically has an adverse effect on a wide variety of properties, such as for example on the optical properties or the melt and processing stability. Good flame retardancy properties are required especially for use in the electricals and electronics sector, for example for reflectors of illumination units.

A lack of processing stability and, directly associated therewith, polycarbonate degradation lead to a rise in the yellowness index (YI), which adversely affects the reflectance.

Optical brighteners that could be added have in turn the disadvantage that their use results in a nonlinear reflectance curve which can lead to a blue tint of the material which is perceived as disruptive.

### SUMMARY OF THE INVENTION

It was therefore an object of the present invention to provide titanium dioxide-containing, polycarbonate-based compositions having a flame retardancy of UL94 V-0 at 1.80 mm wall thickness, preferably at 1.5 mm, good melt stability, demonstrated using the melt volume-flow rate (MVR; Melt Flow Ratio, ISO 1133:2012-03), and in spite of that improved reflectance, and also corresponding molded parts, wherein the compositions, in addition to achieving the properties mentioned, should as far as possible not have significantly poorer flow behavior in processing and should also as far as possible be free of disruptive tints.

Surprisingly, it has been found that graft polymers of (C₁ to C₈)-alkyl (meth)acrylate on a graft base from the group of acrylate rubbers, in particular acrylic core/shell graft polymer based on butyl acrylate rubber, lead to an improvement in the reflectance in flame-retardant, titanium dioxide-containing compositions. At the same time, a positive effect on the yellowness index can generally also be observed. The flow behavior of the compositions is not significantly affected and the good processability in injection molding is retained. Surprisingly, when using flame retardants the flame retardancy properties determined according to UL94 also remain virtually unchanged.

### DETAILED DESCRIPTION

The invention therefore provides thermoplastic compositions, containing
A) 50% to 90.38% by weight of aromatic polycarbonate,
B) 5% to 20% by weight of titanium dioxide,
C1) 0.1% to 0.8% by weight of anti-drip agent,
C2) 0.02% to 0.15% by weight of flame retardant selected from the group of alkali metal, alkaline earth metal or ammonium salts of aliphatic or aromatic sulfonic acid, sulfonamide or sulfonimide derivatives and combinations thereof,
D) 0.5% to 4% by weight of graft polymer of (C₁ to C₈)-alkyl (meth)acrylate on a graft base from the group of acrylate rubbers,
E) 0% to 10% by weight of one or more further additives.

It will be appreciated that “to” includes the respectively mentioned limit value, including the rounding range thereof. It will also be appreciated that the components may also be mixtures of various representatives of the respective species, thus for example a mixture of different aromatic polycarbonates or a mixture of different flame retardants according to component C2.

In the context of the present invention—unless explicitly stated otherwise—the reported % by weight values for the components A, B, C1, C2, D and optionally E are each based on the total weight of the composition. It will be appreciated that all of the components present in a composition according to the invention sum to 100% by weight. In addition to the components A, B, C1, C2 and D, the composition may comprise further components, for instance further additives in the form of component E. The composition may also contain one or more further thermoplastics not covered by any of the components A to E as blend partners (component F).

Examples of thermoplastic polymers other than components A and D and suitable as blend partners are polystyrene, styrene copolymers, aromatic polyesters such as polyethylene terephthalate (PET), PET-cyclohexanedimethanol copolymer (PETG), polyethylene naphthalate (PEN), polybutylene terephthalate (PBT), such as PMMA and also copolymers with styrene, for example transparent polystyrene-acrylonitrile (PSAN), thermoplastic polyurethanes and/or polymers based on cyclic olefins (e.g. TOPAS®, a commercial product from Ticona). These blend partners are preferably used in concentrations of from 0.5% by weight to 10% by weight.

However, it is very particularly preferable when the above-described compositions do not contain any further components, and instead the amounts of components A, B, C1, C2, D and optionally E, in particular in the preferred embodiments described, add up to 100% by weight, i.e. the compositions consist of components A, B, C1, C2, D, optionally E.

It will be appreciated that the components used may contain typical impurities arising for example from their production process. It is preferable to use the purest possible components. It will further be appreciated that these impurities may also be present in the event of an exhaustive formulation of the composition.

The compositions according to the invention are preferably used for producing molded parts. The compositions preferably have a melt volume-flow rate (MVR) of 3 to 40 cm³/(10 min), more preferably of 6 to 30 cm³/(10 min), yet more preferably of 8 to 25 cm³/(10 min), particularly preferably of 9 to 24 cm³/(10 min), determined in accordance with ISO 1133:2012-3 (test temperature 300° C., mass 1.2 kg).

The invention also provides for improving the reflectance, preferably determined in accordance with ASTM E 1331-2015 at a layer thickness of 2 mm, of flame-retardant titanium dioxide-containing polycarbonate compositions, containing the components C1 and C2, by addition of graft polymer of (C₁ to C₈)-alkyl (meth)acrylate on a graft base from the group of acrylate rubbers, particularly preferably of acrylic core/shell graft polymer based on butyl acrylate rubber, very particularly preferably of one having a shell based on polymethylmethacrylate. The improvement in the reflectance is in reference to the corresponding compositions without such a graft polymer, preferably without acrylic core/shell graft polymer based on butyl acrylate rubber (graft base), in particular with polymethylmethacrylate as shell material. An improvement in the yellowness index is preferably also achieved, preferably determined in accordance with ASTM E 313-15 (observer 10°/illuminant: D65) on specimen plaques having a layer thickness of 2 mm. Here too, the reference is as described above. Component D brings about not only an improvement in the reflectance, but also generally at the same time the degradation during compound production is reduced and the melt is stabilized during the injection molding process, which constitutes an exceptional combination of effects.

The compositions the reflectance of which is further improved through addition of component D have a reflectance before addition of component D preferably of at least 95%, determined in accordance with ASTM E 1331-2015 at a layer thickness of 2 mm.

Of course, the features mentioned as preferred, particularly preferred, and so on, for the composition also apply with regard to the use according to the invention.

The individual constituents of the compositions according to the invention are more particularly elucidated hereinbelow:

### Component A

For the purposes of the invention, the term “polycarbonate” is understood to mean both aromatic homopolycarbonates and aromatic copolycarbonates. These polycarbonates may be linear or branched in the familiar manner. According to the invention, it is also possible to use mixtures of polycarbonates.

Compositions according to the invention contain as component A 50% by weight to 90.38% by weight of aromatic polycarbonate. In accordance with the invention, a proportion of at least 50% by weight of aromatic polycarbonate in the overall composition means that the composition is based on aromatic polycarbonate. The amount of the aromatic polycarbonate in the composition is preferably 65.05% by weight to 90.38% by weight, more preferably 78.08% by weight to 88.86% by weight, it being possible for a single polycarbonate or a mixture of two or more polycarbonates to be present. The polycarbonates present in the compositions are produced in a known manner from dihydroxyaryl compounds, carbonic acid derivatives, and optionally chain terminators and branching agents.

Details of the production of polycarbonates have been set out in many patent specifications over the past 40 years or so. Reference may be made here to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertnd, BAYER AG, “Polycarbonates” in Encyclopedia of Polymer Science and Engineering, Volume 11, Second Edition, 1988, pages 648-718 and finally to U. Grigo, K. Kirchner and P. R. Müller “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117-299.

Aromatic polycarbonates are produced, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Likewise possible is production via a melt polymerization method, by reacting dihydroxyaryl compounds with diphenyl carbonate, for example.

Dihydroxyaryl compounds suitable for the production of polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein, and the ring-alkylated, ring-arylated and ring-halogenated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (I) to (III)

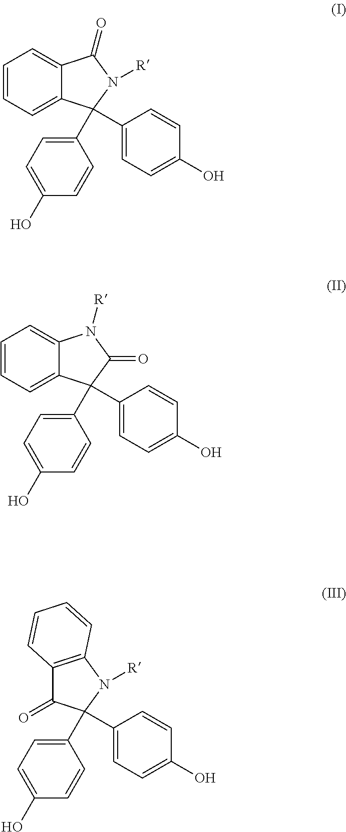

in which each R′ is C₁- to C₄-alkyl, aralkyl or aryl, preferably methyl or phenyl, very particularly preferably methyl.

Particularly preferred bisphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (I), (II) and (III).

These and other suitable dihydroxyaryl compounds are described by way of example in U.S. Pat. Nos. 3,028,365 A, 2,999,825 A, 3,148,172 A, 2,991,273 A, 3,271,367 A, 4,982,014 A and 2,999,846 A, in DE 1 570 703 A, DE 2063 050 A, DE 2 036 052 A, DE 2 211 956 A and DE 3 832 396 A, in FR 1 561 518 A, in the monograph “H. Schnell, Chemistry and Physics of Polycarbonates, Interscience Publishers, New York 1964” and also in JP 62039/1986 A, JP 62040/1986 A and JP 105550/1986 A.

In the case of homopolycarbonates only one dihydroxyaryl compound is used; in the case of copolycarbonates two or more dihydroxyaryl compounds are used.

Examples of suitable carbonic acid derivatives are phosgene or diphenyl carbonate.

Suitable chain terminators that may be employed in the production of the polycarbonates are monophenols. Examples of suitable monophenols include phenol itself, alkylphenols such as cresols, p-tert-butylphenol, cumylphenol, and also mixtures thereof.

Preferred chain terminators are the phenols which have substitution by one or more linear or branched, preferably unsubstituted, C₁ to C₃₀-alkyl radicals, or by tert-butyl. Particularly preferred chain terminators are phenol, cumylphenol and/or p-tert-butylphenol.

The amount of chain terminator to be used is preferably 0.1 to 5 mol %, based on moles of dihydroxyaryl compounds used in each case. The chain terminators may be added before, during or after the reaction with a carbonic acid derivative.

Suitable branching agents are the trifunctional or more than trifunctional compounds known in polycarbonate chemistry, in particular those having three or more than three phenolic OH groups.

Examples of suitable branching agents are 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane, and 1,4-bis((4′,4″-dihydroxytriphenyl)methyl)benzene, and 3,3-bis(3-methyl-4-hydroxyphenyl)-2-oxo-2,3-dihydroindole.

The amount of any branching agents to be used is preferably 0.05 mol % to 2.00 mol %, based on moles of dihydroxyaryl compounds used in each case.

The branching agents can either form an initial charge with the dihydroxyaryl compounds and the chain terminators in the aqueous alkaline phase or can be added, dissolved in an organic solvent, before the phosgenation. In the case of the transesterification method, the branching agents are used together with the dihydroxyaryl compounds.

Particularly preferred polycarbonates are the homopolycarbonate based on bisphenol A, the copolycarbonates based on 1,1-bis(4-hydroxyphenyl)-3,3,5-trimethylcyclohexane and 4,4′-dihydroxydiphenyl and also the copolycarbonates based on the two monomers bisphenol A and 1,1-bis(4-hydroxyphenyl)-3,3,5-trimethylcyclohexane, and also homo- or copolycarbonates derived from the dihydroxyaryl compounds of formulae (I), (II) and (III)

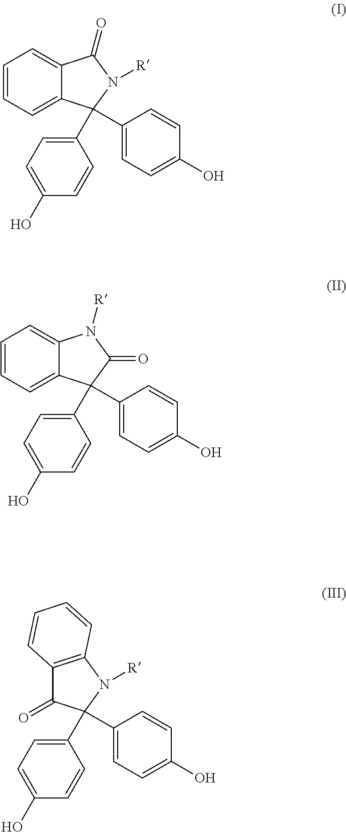

in which each R′ is C₁- to C₄-alkyl, aralkyl or aryl, preferably methyl or phenyl, very particularly preferably methyl,

in particular with bisphenol A.

Also preferred are copolycarbonates produced using diphenols of general formula (Ia):

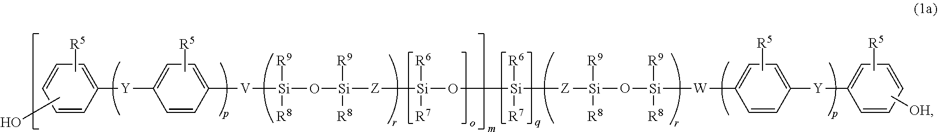

in which
R⁵ represents hydrogen or C₁- to C₄-alkyl, C₁- to C₃-alkoxy, preferably hydrogen, methoxy or methyl,
R⁶, R⁷, R⁸ and R⁹ each independently of one another represent C₁- to C₄-alkyl or C₆- to C₁₂-aryl, preferably methyl or phenyl,
Y represents a single bond, SO₂—, —S—, —CO—, —O—, C₁- to C₆-alkylene, C₂- to C₅-alkylidene, C₆- to C₁₂-arylene which may optionally be fused to further aromatic rings containing heteroatoms or represents a C₅- to C₆-cycloalkylidene radical which may be mono- or polysubstituted by C₁- to C₄-alkyl, preferably represents a single bond, —O—, isopropylidene or a C₅- to C₆-cycloalkylidene radical which may be mono- or polysubstituted by C₁- to C₄-alkyl,
V represents oxygen, C₂- to C₆-alkylene or C₃- to C₆-alkylidene, preferably oxygen or C₃-alkylene,
p, q and r are each independently 0 or 1,
when q=0, W represents a single bond, when q=1 and r=0, W represents oxygen, C₂- to C₆-alkylene or C₃- to C₆-alkylidene, preferably oxygen or C₃-alkylene,
when q=1 and r=1, W and V each independently represent C₂- to C₆-alkylene or C₃- to C₆-alkylidene, preferably C₃-alkylene,
Z represents a C₁- to C₆-alkylene, preferably C₂-alkylene,
represents an average number of repeating units of from 10 to 500, preferably 10 to 100, and
m represents an average number of repeating units of from 1 to 10, preferably 1 to 6, more preferably 1.5 to 5. It is likewise possible to use diphenols in which two or more siloxane blocks of general formula (1a) are joined to one another via terephthalic acid and/or isophthalic acid to form ester groups.

Especial preference is given to (poly)siloxanes of formulae (2) and (3)

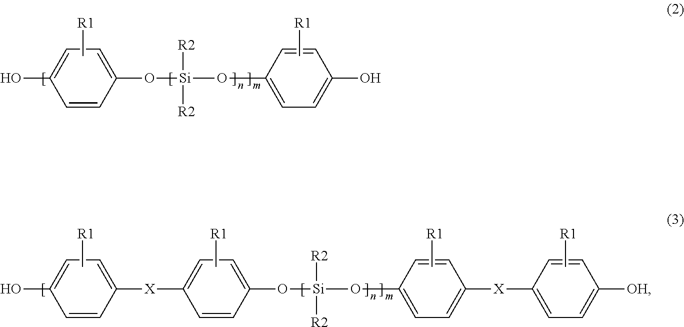

in which R1 represents hydrogen, C₁- to C₄-alkyl, preferably hydrogen or methyl and especially preferably hydrogen,
each R2 independently represents aryl or alkyl, preferably methyl,
X represents a single bond, —SO₂—, —CO—, —O—, —S—, C₁- to C₆-alkylene, C₂- to C₅-alkylidene or C₆- to C₁₂-arylene which may optionally be fused to further aromatic rings containing heteroatoms,
X preferably represents a single bond, C₁- to C₅-alkylene, C₂- to C₅-alkylidene, C₅- to C₁₂-cycloalkylidene, —O—, —SO— —CO—, —S—, —SO₂—, particularly preferably X represents a single bond, isopropylidene, C₅- to C₁₂-cycloalkylidene or oxygen, and very particularly preferably represents isopropylidene,
n represents an average number of from 10 to 400, preferably 10 to 100, especially preferably 15 to 50 and
m represents an average number of from 1 to 10, preferably from 1 to 6 and especially preferably from 1.5 to 5.

The siloxane block may likewise preferably be derived from the following structure

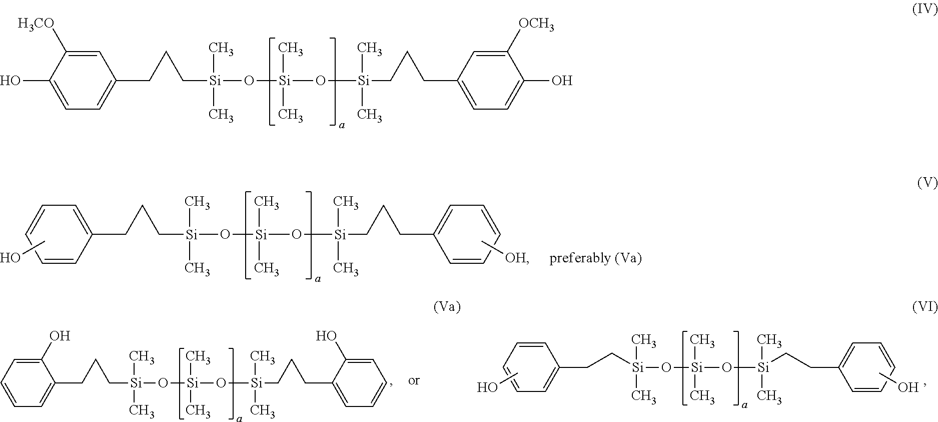

wherein a in formulae (IV), (V) and (VI) represents an average number of from 10 to 400, preferably 10 to 100 and particularly preferably 15 to 50.

It is likewise preferable when at least two identical or different siloxane blocks of general formulae (IV), (V) or (VI) are joined to one another via terephthalic acid and/or isophthalic acid to form ester groups.

It is likewise preferable when in formula (1a) p=0, V represents C₃-alkylene, r=1, Z represents C₂-alkylene, R⁸ and R⁹ represent methyl, q=1, W represents C₃-alkylene, m=1, R⁵ represents hydrogen or C₁- to C₄-alkyl, preferably hydrogen or methyl, R⁶ and R⁷ each independently of one another represent C₁- to C₄-alkyl, preferably methyl, and o is 10 to 500.

Copolycarbonates having monomer units of formula (1a) and in particular also the production thereof are described in WO 2015/052106 A2.

Copolycarbonates having monomer units of formula (IV) and in particular also the production thereof are described in WO 2015/052106 A2.

The thermoplastic polycarbonates, including the thermoplastic aromatic polyestercarbonates, preferably have weight-average molecular weights M. of 15 000 g/mol to 40 000 g/mol, more preferably to 34 000 g/mol, particularly preferably of 17 000 g/mol to 33 000 g/mol, in particular of 19 000 g/mol to 32 000 g/mol, determined by gel permeation chromatography, calibrated against bisphenol A polycarbonate standards using dichloromethane as eluent, calibration with linear polycarbonates (formed from bisphenol A and phosgene) of known molar mass distribution from PSS Polymer Standards Service GmbH, Germany, and calibration by method 2301-0257502-09D (2009 German-language edition) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. Use of UV and/or RI detection.

To achieve incorporation of additives, component A is preferably employed in the form of powders, pellets or mixtures of powders and pellets.

### Component B

Compositions according to the invention contain 5% by weight to 20% by weight, preferably 8.0% by weight to 18.0% by weight, particularly preferably 10.0% by weight to 15.0% by weight, very particularly preferably 11.0% by weight to 13.0% by weight, of titanium dioxide.

The titanium dioxide of component B of the compositions according to the invention preferably has a median particle size D₅₀, determined by scanning electron microscopy (STEM), of 0.1 to 5 μm, preferably 0.2 μm to 0.5 μm. However, the titanium dioxide may also have a different particle size, for example a median particle size D₅₀, determined by scanning electron microscopy (STEM), of ≥0.5 μm, for instance 0.65 to 1.15 μm.

The titanium dioxide preferably has a rutile structure.

The titanium dioxide used in accordance with the invention is a white pigment, Ti(IV)O₂. Colored titanium dioxides contain not only titanium but also elements such as Sb, Ni, Cr in significant amounts, so as to result in a color impression other than “white”. It will be appreciated that traces of other elements may also be present as impurities in the titanium dioxide white pigment. However, these amounts are so small that the titanium dioxide does not take on any tint as a result.

Suitable titanium dioxides are preferably those produced by the chloride process, hydrophobized, specially aftertreated and suitable for use in polycarbonate. Instead of sized titanium dioxide, compositions according to the invention may in principle also employ unsized titanium dioxide or a mixture of both. However, the use of sized titanium dioxide is preferred.

Possible surface modifications of titanium dioxide include inorganic and organic modifications. These include for example aluminum- or polysiloxane-based surface modifications. An inorganic coating may contain 0.0% by weight to 5.0% by weight of silicon dioxide and/or aluminum oxide. An organic-based modification may contain 0.0% by weight to 3.0% by weight of a hydrophobic wetting agent. The titanium dioxide preferably has an oil absorption number determined according to DIN EN ISO 787-5:1995-10, of 12 to 18 g/100 g of titanium dioxide, more preferably of 13 to 17 g/100 g of titanium dioxide, particularly preferably of 13.5 to 15.5 g/100 g of titanium dioxide.

Particular preference is given to titanium dioxide having the standard designation R2 according to DIN EN ISO 591-1:2001-08, which is stabilized with aluminum and/or silicon compounds and has a titanium dioxide content of at least 96.0% by weight. Such titanium dioxides are available under the brand names Kronos 2233 and Kronos 2230.

### Component C1

The compositions according to the invention contain as component C1 an anti-drip agent, which may be a mixture of two or more anti-drip agents. The total amount of anti-drip agent (anti-dripping agent) is 0.1% by weight to 0.8% by weight, in particular 0.10% by weight to 0.8% by weight, preferably 0.15% by weight to 0.7% by weight, particularly preferably 0.4% by weight to 0.6% by weight, of at least one anti-drip agent.

As the anti-dripping agent, a fluorinated polymer, in particular polyolefin, is preferably used.

The fluorinated polyolefins used with particular preference as anti-dripping agents have high molecular weight and have glass transition temperatures of above −30° C., generally of above 100° C., and fluorine contents preferably of from 65% by weight to 76% by weight, in particular from 70% to 76% by weight. Preferred fluorinated polyolefins are polytetrafluoroethylene, polyvinylidene fluoride, tetrafluoroethylene/hexafluoropropylene copolymers and ethylene/tetrafluoroethylene copolymers. Fluorinated polyolefins are known (cf. “Vinyl and Related Polymers” by Schildknecht, John Wiley & Sons, Inc., New York, 1962, pages 484-494; “Fluoropolymers” by Wall, Wiley-Interscience, John Wiley & Sons, Inc., New York, volume 13, 1970, pages 623-654; “Modern Plastics Encyclopedia”, 1970-1971, volume 47, No. 10 A, October 1970, McGraw-Hill, Inc., New York, pages 134 and 774; “Modern Plastics Encyclopedia”, 1975-1976, October 1975, volume 52, No. 10 A, McGraw-Hill, Inc., New York, pages 27, 28 and 472 and U.S. Pat. Nos. 3,671,487, 3,723,373 and 3,838,092).

They can be produced by known methods, for example by polymerizing tetrafluoroethylene in aqueous medium with a free-radical-forming catalyst, for example sodium, potassium or ammonium peroxydisulfate, at pressures of from 7 to 71 kg/cm² and at temperatures of from 0 to 200° C., preferably at temperatures of from 20 to 100° C. More details are given, for example, in U.S. Pat. No. 2,393,967.

Depending on the use form, the density of the fluorinated polyolefins can lie between 1.2 and 2.3 g/cm³, preferably 2.0 g/cm³ to 2.3 g/cm³, determined in accordance with ISO 1183-1 (2019-09), and the median particle size between 0.05 and 1000 μm, determined by light microscopy or white light interferometry.

Suitable tetrafluoroethylene polymer powders are commercial products and are available by way of example from DuPont under the trade name Teflon®.

Particular preference is given to using polytetrafluoroethylene (PTFE) or a PTFE-containing composition. PTFE is commercially available in a variety of product qualities. These include Hostaflon® TF2021 or PTFE blends such as Blendex® B449 (about 50% by weight of PTFE and about 50% by weight of SAN [from 80% by weight of styrene and 20% by weight of acrylonitrile]) from Chemtura. Preference is given to using Blendex® B449.

### Component C2

The compositions according to the invention contain, as component C2, one or more flame retardants selected from the group of alkali metal, alkaline earth metal or ammonium salts of aliphatic or aromatic sulfonic acid, sulfonamide or sulfonimide derivatives. It will be appreciated that a combination of two or more such flame retardants may also be involved. It will also be appreciated that two or more representatives from one of the compound groups mentioned may also be involved.

According to the invention, “derivatives” are understood here and elsewhere to mean those compounds having a molecular structure that bears a different atom or a different group of atoms in place of a hydrogen atom or a functional group or in which one or more atoms/group of atoms have been removed. The parent compound is thus still recognizable.

As flame retardant, compositions according to the invention particularly preferably comprise one or more compounds selected from the group consisting of sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium diphenylsulfone sulfonate, sodium or potassium 2-formylbenzenesulfonate, sodium or potassium (N-benzenesulfonyl)benzenesulfonamide, or mixtures thereof.

Preference is given to using sodium or potassium perfluorobutanesulfate, sodium or potassium perfluorooctanesulfate, sodium or potassium diphenylsulfone sulfonate, or mixtures thereof. Very particular preference is given to potassium perfluoro-1-butanesulfonate, which is commercially available, inter alia, as Bayowet® C4 from Lanxess, Leverkusen, Germany.

The amounts of alkali metal, alkaline earth metal and/or ammonium salts of aliphatic or aromatic sulfonic acid, sulfonamide and sulfonimide derivatives in the composition are 0.02% by weight to 0.15% by weight, preferably 0.04% by weight to 0.12% by weight, particularly preferably 0.05% by weight to 0.10% by weight and very particularly preferably 0.065% by weight to 0.08% by weight.

### Component D

Compositions according to the invention contain 0.5% by weight to 4.0% by weight, preferably 0.8% by weight to 4.0% by weight, particularly preferably 1% by weight to 3.5% by weight, very particularly preferably 1.0% by weight to 3% by weight, in particular up to 3.0% by weight, of component D.

Component D is at least one graft polymer of (C₁ to C₈)-alkyl (meth)acrylate on a graft base from the group of acrylate rubbers.

Preferably, component D is one or more graft polymer(s) of
D.1 5% to 95%, preferably 30% to 90%, by weight, of at least one (C₁ to C₈)-alkyl (meth)acrylate on
D.2 95% to 5%, preferably 70% to 10%, by weight, of at least one graft base selected from the group of acrylate rubbers.

The monomer D.1 more preferably used is methyl methacrylate, alone or in a mixture with further monomers from the group of (C₁ to C₈)-alkyl (meth)acrylates. Particularly preferably, the monomer D.1 is methyl methacrylate.

Suitable acrylate rubbers according to D.2 of the polymers D are preferably polymers of alkyl acrylates, optionally with up to 40% by weight, based on D.2, of other polymerizable, ethylenically unsaturated monomers. Among the preferred polymerizable acrylic esters are C₁- to C₈-alkyl esters, for example methyl, ethyl, butyl, n-octyl and 2-ethylhexyl esters; haloalkyl esters, preferably halo-C₁- to —C₈-alkyl esters, such as chloroethyl acrylate, and also mixtures of these monomers.

Crosslinking may be achieved by copolymerizing monomers comprising more than one polymerizable double bond. Preferred examples of crosslinking monomers are esters of unsaturated monocarboxylic acids having 3 to 8 carbon atoms and unsaturated monohydric alcohols having 3 to 12 carbon atoms, or of saturated polyols having 2 to 4 OH groups and 2 to 20 carbon atoms, such as ethylene glycol dimethacrylate, allyl methacrylate; polyunsaturated heterocyclic compounds, such as trivinyl and triallyl cyanurate; polyfunctional vinyl compounds, such as di- and trivinylbenzenes; but also triallyl phosphate and diallyl phthalate. Preferred crosslinking monomers are allyl methacrylate, ethylene glycol dimethacrylate, diallyl phthalate and heterocyclic compounds which have at least three ethylenically unsaturated groups. Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5%, in particular 0.05% to 2%, by weight, based on the graft base D.2. In the case of cyclic crosslinking monomers having at least three ethylenically unsaturated groups, it is advantageous to limit the amount to below 1% by weight of the graft base D.2.

Examples of preferred “other” polymerizable, ethylenically unsaturated monomers which can optionally serve alongside the acrylic esters for production of the graft base D.2 are acrylonitrile, styrene, α-methylstyrene, acrylamides, vinyl C₁- to C₆-alkyl ethers, methyl methacrylate, butadiene. Preferred acrylate rubbers for use as graft base D.2 are emulsion polymers having a gel content of at least 60% by weight.

The graft base D.2 more preferably used is at least one butyl acrylate rubber, alone or in a mixture with other acrylate rubbers. Particularly preferably, component D.2 is butyl acrylate rubber, very particularly preferably based on n-butyl acrylate.

Preferably, the median particle size (d₅₀ value) of the graft base D.2 is from 0.05 to 10 μm, with preference from 0.1 to 5 μm, particularly preferably from 0.2 to 0.4 μm. The median particle size d₅₀ is the diameter with 50% by weight of the particles above it and 50% by weight of the particles below it. It can be determined by using ultracentrifuge measurement (W. Scholtan, H. Lange, Kolloid, Z. und Z. Polymere 250 (1972), 782-796).

The gel content of the graft base D2 is determined at 25° C. in a suitable solvent (M. Hoffmann, H. Krömer, R. Kuhn, Polymeranalytik I und II [Polymer Analysis I and II], Georg Thieme-Verlag, Stuttgart 1977). The gel content of the graft base D.2 is preferably at least 20% by weight, and in the case of graft bases D.2 produced by the emulsion polymerization process preferably at least 40% by weight (measured in toluene, M. Hoffmann, H. Krämer, R. Kuhn, Polymeranalytik I und II [Polymer Analysis I and II], Georg Thieme-Verlag, Stuttgart 1977).

The graft bases D.2 generally have a glass transition temperature of <10° C., preferably <0° C., particularly preferably <−10° C. The glass transition temperature is determined by using differential scanning calorimetry (DSC) in accordance with the standard DIN EN 61006 (DIN EN 61006:2004-11) at a heating rate of 10 K/min, where T_{g} is defined as midpoint temperature (tangent method).

It is preferable when the graft polymer composed of components D.1 and D.2 has a core-shell structure, wherein component D.1 forms the shell and component D.2 forms the core (see by way of example Ullmann's Encyclopedia of Industrial Chemistry, VCH-Verlag, Vol. A21, 1992, page 635 and page 656).

The graft copolymers D are produced by free-radical polymerization, for example by emulsion, suspension, solution or bulk polymerization, preferably by emulsion or bulk polymerization.

Since, as is well known, the graft monomers are not necessarily entirely grafted onto the graft base in the grafting reaction, in accordance with the invention graft polymers D are also understood to mean those products which are produced via (co)polymerization of the graft monomers in the presence of the graft base and coobtained in the workup.

The weight-average molar weight of the graft polymers used as component D is preferably 15 000 to 200 000 g/mol, particularly preferably 80 000 to 150 000 g/mol, determined by light scattering in methylene chloride. Component D has a melting range of from 130° C. to 150° C.

Particularly suitable as component D is a core/shell graft polymer based on butyl acrylate rubber (butyl acrylate rubber as graft base). Polybutylacrylate is the basis of the core, the shell is preferably based on polymethylmethacrylate. “Based” in this context is to be understood as meaning that it is the main material of the core or the shell, i.e. the material the weight of which makes up at least 50% by weight of the total material of the core or the shell. Very particularly preferably, “based” means that the respective material is the material of the core or the shell. Core/shell graft polymer based on butyl acrylate rubber, in particular with a shell based on polymethylmethacrylate, as a representative of component D can be present as component D alone or in a mixture with further suitable representatives of component D.

### Component E

Optionally present in addition are further additives, preferably up to 10.0% by weight, yet more preferably 0.1% by weight to 6.0% by weight, particularly preferably 0.1% by weight to 3.0% by weight, very particularly preferably 0.2% by weight to 1.0% by weight, in particular up to 0.5% by weight, of other customary additives (“further additives”). The group of further additives does not include titanium dioxide since this has already been described as component B. Likewise, the group of further additives does not include a flame retardant corresponding to component C2 nor an anti-drip agent according to component C1. The group of further additives also does not include a graft polymer according to component D, that is to say a graft polymer of (C₁ to C₈)-alkyl (meth)acrylate on a graft base from the group of acrylate rubbers.

Such further additives, as are typically added to polycarbonates, are in particular heat stabilizers, antioxidants, mold-release agents, UV absorbers, IR absorbers, impact modifiers other than component D, antistats, optical brighteners, fillers other than component B, flame retardants other than component C2, light-scattering agents, hydrolysis stabilizers, compatibilizers and/or additives for laser marking, in particular in the amounts customary for polycarbonate-based compositions. Such additives are described for example in EP-A 0 839 623, WO-A 96/15102, EP-A 0 500 496 or in “Plastics Additives Handbook”, Hans Zweifel, 5th Edition 2000, Hanser Verlag, Munich. These additives may be added individually or else as mixtures. It will be appreciated that it is only permissible to add such additives in such amounts that do not have a significant adverse impact on the effect of the invention of improved reflectance. Compositions according to the invention therefore preferably do not contain any carbon black, for example. An improvement in reflectance relative to corresponding reference compositions that differ from the composition according to the invention only in that they do not contain any impact modifier according to component D must also be observed.

The additives are preferably selected from the group of heat stabilizers, antioxidants, mold-release agents, flame retardants other than component C2, UV absorbers, IR absorbers, impact modifiers other than component D, antistats, optical brighteners, fillers other than component B, light-scattering agents, hydrolysis stabilizers, transesterification inhibitors, compatibilizers and/or additives for laser marking. If additives are present, one or more of these additives may constitute component E in a composition according to the invention.

Additives present with particular preference are heat stabilizers. Suitable heat stabilizers are in particular phosphorus-based stabilizers selected from the group of the phosphates, phosphites, phosphonites, phosphines and mixtures thereof. It is also possible to use mixtures of different compounds from one of these subgroups, for example two phosphites. Heat stabilizers preferably used are phosphorus compounds having the oxidation number +III, in particular phosphines and/or phosphites. Particularly preferably suitable heat stabilizers are triphenylphosphine, tris(2,4-di-tertbutylphenyl) phosphite (Irgafos® 168), tetrakis(2,4-di-tert-butylphenyl)-[1,1-biphenyl]-4,4′-diylbisphosphonite, octadecyl 3-(3,5-di-tert-butyl-4-hydroxyphenyl)propionate (Irganox® 1076), bis(2,4-dicumylphenyl)pentaerythritol diphosphite (Doverphos® S-9228), bis(2,6-di-tert-butyl-4-methylphenyl)pentaerythritol diphosphite (ADK STAB PEP-36). They are used alone or in a mixture, for example Irganox® B900 (mixture of Irgafos® 168 and Irganox® 1076 in a 4:1 ratio) or Doverphos® S-9228 with Irganox® B900/Irganox® 1076. The heat stabilizers are preferably used in amounts of up to 1.0% by weight, more preferably 0.003% by weight to 1.0% by weight, yet more preferably 0.005% by weight to 0.5% by weight, particularly preferably 0.01% by weight to 0.2% by weight.

Preferred additives also include specific UV stabilizers having a lowest possible transmittance below 400 nm and a highest possible transmittance above 400 nm. Ultraviolet absorbers particularly suitable for use in the composition according to the invention are benzotriazoles, triazines, benzophenones and/or arylated cyanoacrylates. Particularly suitable ultraviolet absorbers are hydroxybenzotriazoles, such as 2-(3′,5′-bis(1,1-dimethylbenzyl)-2′-hydroxyphenyl)benzotriazole (Tinuvin® 234, BASF SE, Ludwigshafen), 2-(2′-hydroxy-5′-(tert-octyl)phenyl)benzotriazole (Tinuvin® 329, BASF SE, Ludwigshafen), bis(3-(2H-benzotriazolyl)-2-hydroxy-5-tert-octyl)methane (Tinuvin® 360, BASF SE, Ludwigshafen), 2-(4,6-diphenyl-1,3,5-triazin-2-yl)-5-(hexyloxy)phenol (Tinuvin® 1577, BASF SE, Ludwigshafen), 2-(5-chloro-2H-benzotriazol-2-yl)-6-(1,1-dimethylethyl)-4-methylphenol (Tinuvin® 326, BASF SE, Ludwigshafen), and also benzophenones such as 2,4-dihydroxybenzophenone (Chimassorb® 22, BASF SE, Ludwigshafen) and 2-hydroxy-4-(octyloxy)benzophenone (Chimassorbo 81, BASF SE, Ludwigshafen), 2,2-bis[[(2-cyano-1-oxo-3,3-diphenyl-2-propenyl)oxy]methyl]-1,3-propanediyl ester (9CI) (Uvinul 3030, BASF SE Ludwigshafen), 2-[2-hydroxy-4-(2-ethylhexyl)oxy]phenyl-4,6-di(4-phenyl)phenyl-1,3,5-triazine (Tinuvin® 1600, BASF SE, Ludwigshafen), tetraethyl 2,2′-(1,4-phenylenedimethylidene)bismalonate (Hostavin B-Cap, Clariant AG) or N-(2-ethoxyphenyl)-N′-(2-ethylphenyl)ethanediamide (Tinuvin® 312, CAS no. 23949-66-8, BASF SE, Ludwigshafen). Particularly preferred specific UV stabilizers are Tinuvin® 360, Tinuvin® 329, Tinuvin® 326, Tinuvin® 1600, Tinuvin® 312, Uvinul® 3030 and/or Hostavin B-Cap, and very particularly preferred are Tinuvin® 329 and Tinuvin® 360.

It is also possible to use mixtures of the abovementioned ultraviolet absorbers.

If UV absorbers are present, the composition preferably contains ultraviolet absorbers in an amount of up to 0.8% by weight, preferably 0.05% by weight to 0.5% by weight, more preferably 0.08% by weight to 0.4% by weight, very particularly preferably 0.1% by weight to 0.35% by weight, based on the overall composition.

The compositions according to the invention may also contain phosphates or sulfonic esters as transesterification inhibitors. A transesterification inhibitor that is preferably present is triisooctyl phosphate. Triisooctyl phosphate is preferably used in amounts of from 0.003% by weight to 0.05% by weight, more preferably 0.005% by weight to 0.04% by weight and particularly preferably from 0.01% by weight to 0.03% by weight, based on the overall composition.

Examples of impact modifiers other than component D are: other core-shell polymers such as ABS or MBS; olefin-acrylate copolymers such as for example the Elvaloy® types from DuPont; silicone acrylate rubbers such as for example the Metablen® types from Mitsubishi Rayon Co., Ltd.

The further additive present is particularly preferably at least one selected from the group consisting of heat stabilizers, mold-release agents, antioxidants, impact modifiers other than component D, in particular in an amount of from 0% to 3% by weight. Mixtures of two or more of the aforementioned additives may also be present.

The compositions according to the invention are preferably free from optical brighteners.

Preferred compositions according to the invention contain
A) 78.08% to 88.86% by weight of aromatic polycarbonate,
B) 10% to 15% by weight of titanium dioxide,
C1) 0.1% to 0.8% by weight of anti-drip agent,
C2) 0.04% to 0.12% by weight of flame retardant selected from the group of alkali metal, alkaline earth metal or ammonium salts of aliphatic or aromatic sulfonic acid, sulfonamide or sulfonimide derivatives and combinations thereof,
D) 1% to 3% by weight of graft polymer of (C₁ to C₈)-alkyl (meth)acrylate on a graft base from the group of acrylate rubbers,
E) 0% to 3% by weight of further additives.

More preferably, the graft polymer of (C₁ to C₈)-alkyl (meth)acrylate on a graft base from the group of acrylate rubbers according to component D is a core/shell graft polymer based on butyl acrylate rubber (core), in particular one with a shell based on polymethylmethacrylate.

Yet more preferably, this is the sole graft polymer according to component D present in the composition.

The compositions according to the invention particularly preferably do not contain any further components, and instead the compositions according to the invention consist of the components A to E mentioned.

Very particularly preferably, at least one additive from the group consisting of heat stabilizers and impact modifiers other than component D is present in the compositions according to the invention. Additional additives from the group of further additives according to component E may also be present, but do not need to be.

The compositions according to the invention, containing components A to D and optionally E and optionally blend partners, are produced by standard incorporation processes via combination, mixing and homogenization of the individual constituents, especially with the homogenization preferably taking place in the melt under the action of shear forces. Combination and mixing is optionally effected prior to melt homogenization using powder premixes.

It is also possible to use premixes of pellets, or of pellets and powders, with components B, C1, C2, D, and optionally E.

It is also possible to use premixes produced from solutions of the mixture components in suitable solvents where homogenization is optionally effected in solution and the solvent is then removed. In particular, the components B to E of the compositions according to the invention may be introduced into the polycarbonate, optionally into the polycarbonate with blend partners, here by known processes or in the form of a masterbatch.

Preference is given to the use of masterbatches for introducing components B to E, individually or in a mixture.

In this connection, the composition according to the invention can be combined, mixed, homogenized and subsequently extruded in customary apparatuses such as screw extruders (TSE, twinscrew extruders for example), kneaders or Brabender or Banbury mills. The extrudate may be cooled and comminuted after extrusion. It is also possible to premix individual components and then to add the remaining starting materials individually and/or likewise mixed.

The combining and mixing of a premix in the melt may also be effected in the plasticizing unit of an injection molding machine. In this case, the melt is directly converted into a molded article in the subsequent step.

The compositions according to the invention can be processed in a customary manner in standard machines, for example in extruders or injection molding machines, to give any molded articles, for example films, sheets or bottles.

The compositions/moldings made from the compositions appear “brilliant white” to the observer.

Production of the moldings is preferably effected by injection molding, extrusion or from solution in a casting process.

The compositions according to the invention are suitable for producing multilayered systems. The polycarbonate-containing composition is applied in one or more layers to a molded object made of a plastic or itself serves as a substrate layer upon which one or more further layers are applied. Application may be carried out at the same time as or immediately after the molding of the molded article, for example by in-mold coating of a film, coextrusion or multicomponent injection molding. However, application can also take place onto the finished molded main body, for example by lamination with a film, insert molding of an existing molded article or by coating from a solution. The compositions according to the invention are suitable for producing components in the lighting sector, such as reflectors or parts of reflectors for lamps, in particular LED lamps or LED arrays, in the automotive sector, for example for bezels, switches, headlight reflectors or frames, and for producing frames or frame parts or housing or housing parts in the EE (electricals/electronics) and IT sector. On account of the very good reflectance values, the compositions according to the invention are preferably used for producing reflectors.

These and other moldings consisting of the compositions according to the invention or, for example in the case of multicomponent injection molding, comprising these, including moldings constituting a layer of a multilayered system or an element of an abovementioned component or one such component and made from (“consisting of”) these compositions according to the invention, likewise form part of the subject matter of the present application. The compositions according to the invention are also usable as 3D printing material in the form of filaments, as pellets or powder.

The embodiments described hereinabove for the compositions according to the invention also apply—where applicable—to the use according to the invention.

The examples which follow are intended to illustrate the invention, without limiting said invention.

### Examples

### 1. Description of Raw Materials and Test Methods

The polycarbonate-based compositions described in the following examples were produced by compounding on a Berstorff ZE 25 extruder at a throughput of 10 kg/h. The melt temperature was 275° C.

### a) Raw Materials

Component A-1: Linear polycarbonate based on bisphenol A having a melt volume-flow rate MVR of 19 cm³/(10 min) (according to ISO 1133:2012-03, at a test temperature of 300° C. and with 1.2 kg load) containing 250 ppm of triphenylphosphine as Component E1.

Component A-2: Linear polycarbonate powder based on bisphenol A having a melt volume-flow rate MVR of 19 cm³/(10 min) (according to ISO 1133:2012-03, at a test temperature of 300° C. and with 1.2 kg load).

Component B: Kronos 2230 titanium dioxide from Kronos Titan GmbH, Leverkusen.

Component C1: Blendex® B449 (about 50% by weight of PTFE and about 50% by weight of SAN [from 80% by weight of styrene and 20% by weight of acrylonitrile]) from Chemtura Corporation. Anti-drip agent.

Component C2: Potassium perfluoro-1-butanesulfonate, commercially available as Bayowet® C4 from Lanxess AG, Leverkusen, Germany, CAS no. 29420-49-3.

Component D: Paraloid EXL2300 from Dow. Acrylic core/shell graft polymer formed from methyl methacrylate (shell) and butyl acrylate rubber (core, graft base).

Component E1: Triphenylphosphine, commercially available from BASF SE, Ludwigshafen.

Component E2: Tinuvin 329, UV stabilizer having a benzotriazole structure, commercially available from BASF SE, Ludwigshafen.

Component E3: Epoxidized soybean oil (“D65 soybean oil”) from Avokal GmbH, Wuppertal, having an acid number of ≤0.5 mg KOH/g, determined by DIN EN ISO 2114:2006-11, an oxirane value (epoxide oxygen EO, calculated from the epoxide number EEW, indicates how many grams of oxygen are present per 100 g of oil; EEW determined according to DIN EN 1877:2000-12) of ≥6.3 g of O₂/100 g. Predominantly fully epoxidized triacylglycerols, which are a mixture of triesters of glycerol with oleic acid, linoleic acid, linolenic acid, palmitic acid and/or stearic acid.

### b) Test Methods

Melt volume-flow rate (MVR) was determined in accordance with ISO 1133:2012-03 (predominantly at a test temperature of 300° C., mass 1.2 kg) using a Zwick 4106 instrument from Zwick Roell. In addition, the MVR value was measured after a preheating time of 20 minutes (IMVR20′). This is a measure of melt stability under elevated thermal stress.

The ash content was determined in accordance with DIN 51903:2012-11 (850° C., hold for 30 min).

The total reflectance spectrum was measured on the basis of the standard ASTM E 1331-04 using a spectrophotometer. The transmittance or reflectance spectrum thus obtained was used to calculate the visual transmittance Ty (illuminant D65, observer 10°) or the visual reflectance Ry (illuminant D65, observer 10°) in each case in accordance with ASTM E 308-08. This also applies to the color values L*a*b*. The thickness of the test specimens was 2 mm.

The gloss was determined in accordance with ASTM D 523-14.

The yellowness index (Y.I.) was determined in accordance with ASTM E 313-10 (observer: 10°/illuminant: D65). The thickness of the test specimens was 2 mm.

The flammability of the samples investigated was also assessed and classified, specifically according to UL94. To this end, test specimens measuring 125 mm×13 mm×d (mm) were produced, where the thickness d corresponds to the smallest wall thickness in the intended application. A V0 classification means that the flame self-extinguishes after no more than 10 s. There are no burning drips. Afterglow after second flame contact has a duration of no more than 30 s.

The Vicat softening temperature VST/B50 as a measure of heat distortion resistance was determined in accordance with ISO 306:2013 on test specimens measuring 80 mm×10 mm×4 mm with a 50 N ram load and a heating rate of 50° C./h with the Coesfeld Eco 2920 instrument from Coesfeld Materialtest.

The specimen plaques were in each case produced by injection molding at the melt temperatures reported in the tables which follow.

Comparative experiments are identified below with “V”, and experiments according to the invention with “E”.

TABLE 1

| | | | Example | | | | | | | |
|---|---|---|---|---|---|---|---|---|---|---|
| | | | V-1 | V-2 | V-3 | V-4 | V-5 | E-6 | V-7 | E-8 |
| | | | % by | % by | % by | % by | % by | % by | % by | % by |
| Component | | | wt | wt | wt | wt | wt | wt | wt | wt |
| A1 | | | 80.000 | 80.000 | 80.000 | 80.000 | 80.000 | 80.000 | 80.000 | 80.000 |
| A2 | | | 8.000 | 6.000 | 7.500 | 5.500 | 7.435 | 5.435 | 7.400 | 5.400 |
| B | | | 12.000 | 12.000 | 12.000 | 12.000 | 12.000 | 12.000 | 12.000 | 12.000 |
| C1 | | | | | 0.500 | 0.500 | 0.500 | 0.500 | 0.500 | 0.500 |
| C2 | | | | | | | 0.065 | 0.065 | 0.100 | 0.100 |
| D | | | | 2.000 | | 2.000 | | 2.000 | | 2.000 |
| Test | Condition | Standard/unit | | | | | | | | |
| Ash content | 850° C./0.5 h | [%] | 11.8 | 13.3 | 11.9 | 14.3 | 11.8 | 12.1 | 11.9 | 11.8 |
| MVR | 300° C.; 1.20 kg; 7 min | [cm³/(10 min)] | 19.1 | 15.5 | 10.3 | 7.8 | 12.1 | 8.3 | 13.1 | 8.1 |
| MVR | 300° C.; 1.20 kg; 20 min | [cm³/(10 min)] | 22.0 | 16.8 | 10.9 | 8.6 | 15.7 | 9.8 | 16.0 | 10.8 |
| Delta | | | 2.9 | 1.3 | 0.6 | 0.8 | 3.6 | 1.5 | 2.9 | 2.7 |
| MVR/IMVR20′ | | | | | | | | | | |
| Vicat VST B50 | | [° C.] | 146.4 | 146.7 | 146.8 | 145.9 | 146.6 | 145.8 | 146.2 | 146.5 |
| Fire performance | | | | | | | | | | |
| UL94-V | 1.50 mm | | | | | | | | | |
| Rating (ro) | | | V-2 | V-2 | V-1 | V-1 | V-0 | V-0 | V-0 | V-0 |
| UL94-V | 1.60 mm | | | | | | | | | |
| Rating (ro) | | | V-2 | V-NOT | V-1 | V-1 | V-0 | V-0 | V-0 | V-0 |
| UL94-V | 1.80 mm | | | | | | | | | |
| Rating (ro) | | | V-2 | V-2 | V-0 | V-0 | V-0 | V-0 | V-0 | V-0 |
| Optical data | | | | | | | | | | |
| Reflectance | 2 mm | | | | | | | | | |
| L* (ro) | | | 98.39 | 98.55 | 98.48 | 98.65 | 98.56 | 98.59 | 98.59 | 98.61 |
| a* (ro) | | | −0.57 | −0.62 | −0.6 | −0.62 | −0.61 | −0.6 | −0.61 | −0.6 |
| b* (ro) | | | 2.03 | 1.9 | 2.09 | 1.9 | 2.2 | 2.01 | 2.14 | 1.99 |
| Reflectance (ro) | | | 95.88 | 96.31 | 96.13 | 96.55 | 96.31 | 96.39 | 96.39 | 96.43 |
| Yellowness index | | | 3.32 | 3.03 | 3.41 | 3.03 | 3.6 | 3.26 | 3.48 | 3.21 |
| (ro) | | | | | | | | | | |
| 60° gloss (ro) | | | 102 | 100 | 102 | 100 | 103 | 100 | 103 | 99 |

The combination of flame retardant salt and anti-drip agent provides an effective flame retardant combination, so as to achieve a UL 94 V0 classification as early as at 1.5 mm (V-5 compared to V-1, V-3). The addition of component D, which brings about a significant improvement in reflectance and a noticeable improvement in the yellowness index, does not have an adverse effect on the flame retardancy properties, and a UL94 V0 classification can still be achieved at 1.5 mm (V-5 with E-6, V-7 with E-8). An appreciable negative influence on the heat distortion resistance, represented by the Vicat temperature, as a result of the addition of component D, cannot be identified.

It can further be seen that, as a result of the addition of component E in V-2, V %, E-6 and E-8, melt stabilization arises in each case during the production of the compound (in each case lower MVR than in the corresponding comparative tests). This stabilizing effect can also be observed when the compounds are subjected to thermal stress: The increase in MVR after 20 minutes turns out lower in each of the compounds that contain component D than in the corresponding comparative tests that do not contain component D.

TABLE 2

| | | | Example | | | |
|---|---|---|---|---|---|---|
| | | | V-9 | E-10 | V-11 | E-12 |
| Component | | | % by wt | % by wt | % by wt | % by wt |
| A1 | | | 80.000 | 80.000 | 80.000 | 80.000 |
| A2 | | | 7.400 | 5.435 | 7.285 | 5.285 |
| B | | | 12.000 | 12.000 | 12.000 | 12.000 |
| C1 | | | 0.500 | 0.500 | 0.500 | 0.500 |
| C2 | | | 0.100 | 0.065 | 0.065 | 0.065 |
| D | | | | 2.000 | | 2.000 |
| E3 | | | | | 0.150 | 0.150 |
| Test | Condition | Standard/unit | | | | |
| Ash content | 850° C.; 0.5 h | [%] | 11.7 | 11.8 | 12.0 | 11.9 |
| (average) (ro) | | | | | | |
| MVR | 300° C.; 1.20 kg; 7 min | [cm³/(10 min)] | 12.9 | 8 | 11.9 | 8.2 |
| MVR | 300° C.; 1.20 kg; 20 min | [cm³/(10 min)] | 16.3 | 9.6 | 15.7 | 10.4 |
| Delta MVR/IMVR20′ | | | 3.4 | 1.6 | 3.8 | 2.2 |
| UL94-V | 1.50 mm | | | | | |
| Rating (ro) | | | V-0 | V-0 | V-0 | V-0 |
| UL94-V | 2.00 mm | | | | | |
| Rating (ro) | | | V-0 | V-0 | V-0 | V-0 |
| Reflectance | Hunter UltraScanPRO, | ASTM E 1331 | | | | |
| | Diffuse/8°; D65; 10° | with gloss | | | | |
| Sample thickness (ro) | | mm | 2 | 2 | 2 | 2 |
| L* (ro) | | | 98.25 | 98.42 | 98.32 | 98.48 |
| a* (ro) | | | −0.52 | −0.58 | −0.59 | −0.63 |
| b* (ro) | | | 2.22 | 2.08 | 2.1 | 1.94 |
| Reflectance (ro) | | | 95.55 | 95.97 | 95.71 | 96.12 |
| Yellowness index (ro) | | | 3.7 | 3.41 | 3.43 | 3.1 |
| 60° gloss (ro) | | | 102 | 100 | 102 | 100 |

The combination of flame retardant salt and anti-drip agent provides an effective flame retardant combination, so as to achieve a UL94 V0 classification as early as at 1.5 mm. The addition of component D, which brings about a significant improvement in reflectance and a noticeable improvement in the yellowness index, does not have an adverse effect on the flame retardancy properties, and a UL94 V0 classification can still be achieved at 1.5 mm (comparison of V-9 with E-10 and V-11 with E-12).

It can further be seen that, as a result of the addition of component E in E-10 and E-12, melt stabilization arises in each case during the production of the compound (in each case lower MVR than in the corresponding comparative tests). This stabilizing effect can also be observed when the compounds are subjected to thermal stress: The increase in MVR after 20 minutes turns out lower in each of the compounds that contain component D than in the corresponding comparative tests that do not contain component D.

TABLE 3

| | | | Example | | | |
|---|---|---|---|---|---|---|
| | | | V-13 | E-14 | E-15 | V-16 |
| Component | | | % by wt | % by wt | % by wt | % by wt |
| A1 | | | 80.000 | 80.000 | 80.000 | 80.000 |
| A2 | | | 7.435 | 5.435 | 5.235 | 7.085 |
| B | | | 12.000 | 12.000 | 12.000 | 12.000 |
| C1 | | | 0.500 | 0.500 | 0.500 | 0.500 |
| C2 | | | 0.065 | 0.065 | 0.065 | 0.065 |
| D | | | | 2.000 | 2.000 | |
| E2 | | | | | 0.200 | 0.200 |
| Test | Condition | Standard/unit | | | | |
| Ash content | 850° C./0.5 h | [%] | 12.06 | 11.99 | 10.45 | 11.73 |
| (average) | rapid ash | | | | | |
| MVR | 300° C.; | [cm³/(10 min)] | 13.9 | 8.7 | 8.8 | 16.0 |
| | 1.20 kg; 7 min | | | | | |
| MVR | 300° C.; | [cm³/(10 min)] | 15.4 | 11.5 | 12.3 | 16.9 |
| | 1.20 kg; 20 min | | | | | |
| Delta MVR/IMVR20′ | | | 1.5 | 2.8 | 3.5 | 0.9 |
| Fire performance | | | | | | |
| UL94-V | 1.50 mm | | | | | |
| Rating | | | V-0 | V-0 | V-0 | V-0 |
| UL94-V | 2.00 mm | | | | | |
| Rating | | | V-0 | V-0 | V-0 | V-0 |
| Opt. data | | | | | | |
| Reflectance | Hunter UltraScanPRO, | ASTM E 1331 | | | | |
| | Diffuse/8°; D65; 10° | with gloss | | | | |
| Sample thickness (ro) | | [mm] | 2 | 2 | 2 | 2 |
| L* (ro) | | | 98.44 | 98.66 | 98.6 | 98.44 |
| a* (ro) | | | −0.56 | −0.57 | −0.59 | −0.6 |
| b* (ro) | | | 2.1 | 1.91 | 2.07 | 2.04 |
| Reflectance (ro) | | [%] | 96.02 | 96.57 | 96.42 | 96.02 |
| Yellowness index (ro) | | | 3.45 | 3.09 | 3.38 | 3.32 |
| 60° gloss (ro) | | | 102 | 100 | 100 | 100 |

The combination of flame retardant salt and anti-drip agent provides an effective flame retardant combination, so as to achieve a UL94 V0 classification as early as at 1.5 mm. The addition of component D, which brings about a significant improvement in reflectance and a noticeable improvement in the yellowness index, does not have an adverse effect on the flame retardancy properties, and a UL94 V0 classification can still be achieved at 1.5 mm (comparison of V-13 with E-14 and E-15 with V-16).

It can further be seen that, as a result of the addition of component E in E-14 and E-15, melt stabilization arises in each case during the production of the compound (in each case lower MVR than in the corresponding comparative tests). This stabilizing effect can also be observed when the compounds are subjected to thermal stress: The increase in MVR after 20 minutes turns out lower in each of the compounds that contain component D than in the corresponding comparative tests that do not contain component D.

TABLE 4

| | | | Example | | | | | | | |
|---|---|---|---|---|---|---|---|---|---|---|
| | | | V-17 | E-18 | E-19 | V-20 | E-21 | E-22 | V-23 | E-24 |
| | | | % by | % by | % by | % by | % by | % by | % by | % by |
| Component | | | wt | wt | wt | wt | wt | wt | wt | wt |
| A-1 | | | 83.00 | 83.00 | 83.00 | 83.00 | 83.00 | 83.00 | 81.00 | 81.00 |
| A-2 | | | 6.42 | 5.42 | 3.42 | 6.51 | 5.51 | 3.51 | 6.21 | 4.21 |
| D | | | | 1.00 | 3.00 | | 1.00 | 3.00 | | 2.00 |
| C-1 | | | 0.50 | 0.50 | 0.50 | 0.40 | 0.40 | 0.40 | 0.50 | 0.50 |
| C-2 | | | 0.08 | 0.08 | 0.08 | 0.09 | 0.09 | 0.09 | 0.09 | 0.09 |
| E2 | | | | | | | | | 0.20 | 0.20 |
| B | | | 10.00 | 10.00 | 10.00 | 10.00 | 10.00 | 10.00 | 12.00 | 12.00 |
| Test | Condition | Standard/unit | | | | | | | | |
| MVR | 300° C.; | [cm³/(10 min)] | 12.2 | 9.7 | 8.1 | 13.8 | 8.8 | 10.6 | 13 | 8 |
| | 1.20 kg; 7 min | | | | | | | | | |
| IMVR20′ | 300° C.; | [cm³/(10 min)] | 15.3 | 11.4 | 9.2 | 17.9 | 9.5 | 12.4 | 17 | 9.5 |
| | 1.20 kg; 20 min | | | | | | | | | |
| Delta MVR/IMVR20′ | | | 3.1 | 1.7 | 1.1 | 4.1 | 0.7 | 1.8 | 4.0 | 1.5 |
| UL94-V | 1.80 mm | | V-0 | V-0 | V-0 | V-0 | V-0 | V-0 | V-0 | V-0 |
| Rating | | | | | | | | | | |
| Reflectance 2 mm | Hunter UltraScanPRO, | ASTM E 1331 | | | | | | | | |
| | Diffuse/8°; D65; 10° | with gloss | | | | | | | | |
| Sample thickness | | mm | 2 | 2 | 2 | 2 | 2 | 2 | 2 | 2 |
| L* | | | 98.21 | 98.29 | 98.32 | 98.38 | 98.32 | 98.36 | 98.4 | 98.5 |
| a* | | | −0.5 | −0.53 | −0.53 | −0.54 | −0.55 | −0.54 | −0.55 | −0.57 |
| b* | | | 2.12 | 2 | 2 | 2.07 | 2.03 | 2.08 | 2.12 | 2.04 |
| Reflectance | | % | 95.43 | 95.65 | 95.73 | 95.88 | 95.72 | 95.82 | 95.92 | 96.16 |
| Yellowness index | | | 3.55 | 3.29 | 3.29 | 3.42 | 3.34 | 3.43 | 3.51 | 3.34 |
| 60° gloss | | | 103 | 102 | 102 | 102 | 101 | 101 | 101 | 102 |

The combination of flame retardant salt and anti-drip agent provides an effective flame retardant combination, so as to achieve a UL 94 V0 classification as early as at 1.8 mm (V-0). The addition of component D, which brings about a significant improvement in reflectance and an improvement in the yellowness index, does not have an adverse effect on the flame retardancy properties, and a UL94 V0 classification can still be achieved at 1.8 mm (E-8, E-19, E-21, E-22 and E-24). The V0 classification is retained even when adding a UV absorber (V-23 and E-24). The addition of component D brings about an improvement in reflectance and a marked stabilization of the melt, recognizable by the lower MVR and IMVR, each compared to the corresponding formulations without component D.

1. A thermoplastic composition, containing
A) 50% to 90.38% by weight of aromatic polycarbonate,
B) 5% to 20% by weight of titanium dioxide,
C1) 0.1% to 0.8% by weight of anti-drip agent,
C2) 0.02% to 0.15% by weight of flame retardant selected from the group of alkali metal, alkaline earth metal or ammonium salts of aliphatic or aromatic sulfonic acid, sulfonamide or sulfonimide derivatives and combinations thereof,
D) 0.5% to 4% by weight of graft polymer of (C₁ to C₈)-alkyl (meth)acrylate on a graft base from the group of acrylate rubbers,
E) 0% to 10% by weight of one or more further additives.

2. The thermoplastic composition as claimed in claim 1, containing 65.05% to 90.38% by weight of the aromatic polycarbonate.

3. The thermoplastic composition as claimed in claim 1, wherein the further additives are selected from the group consisting of heat stabilizers, antioxidants, mold-release agents, UV absorbers, IR absorbers, impact modifiers other than component D, antistats, optical brighteners, fillers other than component B, flame retardants other than component C2, light-scattering agents, hydrolysis stabilizers, compatibilizers and/or additives for laser marking, and combinations thereof.

4. The thermoplastic composition as claimed in claim 1, containing
A) 78.08% to 88.86% by weight of aromatic polycarbonate,
B) 10% to 15% by weight of titanium dioxide,
C1) 0.1% to 0.8% by weight of anti-drip agent,
C2) 0.04% to 0.12% by weight of flame retardant selected from the group of alkali metal, alkaline earth metal or ammonium salts of aliphatic or aromatic sulfonic acid, sulfonamide or sulfonimide derivatives and combinations thereof,
D) 1% to 3% by weight of graft polymer of (C₁ to C₈)-alkyl (meth)acrylate on a graft base from the group of acrylate rubbers,
E) 0% to 3% by weight of further additives.

5. The thermoplastic composition as claimed in claim 2, wherein the composition does not contain any further components.

6. The thermoplastic composition as claimed in claim 1, wherein the anti-drip agent contains polytetrafluoroethylene.

7. The thermoplastic composition as claimed in claim 1, wherein component D comprises a core/shell graft polymer with butyl acrylate rubber as graft base.

8. The thermoplastic composition as claimed in claim 1, wherein component D is a core/shell graft polymer with butyl acrylate rubber as graft base.

9. The thermoplastic composition as claimed in claim 7, wherein the shell of the core/shell graft polymer with butyl acrylate rubber as graft base is based on polymethylmethacrylate.

10. A molded part made of a thermoplastic composition as claimed in claim 1.

11. The molded part as claimed in claim 10, wherein the molded part is a reflector or part of a reflector for an LED illumination unit.

12. A method for improving a reflectance and/or a yellowness index of a titanium dioxide-containing polycarbonate composition containing one or more flame retardants selected from the group of alkali metal, alkaline earth metal or ammonium salts of aliphatic or aromatic sulfonic acid, sulfonamide or sulfonimide derivatives and combinations thereof, and anti-drip agent, the method comprising providing a graft polymer of (C₁ to C₈)-alkyl (meth)acrylate on a graft base from the group of acrylate rubbers to the polycarbonate composition.

13. The method as claimed in claim 12, wherein the graft polymer comprises a graft polymer formed of methyl methacrylate on the graft base butyl acrylate.
